(19) United States
(12) Patent Application Publication
(10) Pub. No.: US 2009/0213950 A1
(43) Pub. Date: Aug. 27, 2009

(54) PILOT SIGNAL TRANSMISSION FOR AN ORTHOGONAL FREQUENCY DIVISION WIRELESS COMMUNICATION SYSTEM

(75) Inventors: Alexei Gorokhov, San Diego, CA (US); Ayman Fawzy Naguib, Cupertino, CA (US); Arak Sutivong, Bangkok (TH); Dhananjay Ashok Gore, San Diego, CA (US); Tingfang Ji, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/276,649

(22) Filed: Nov. 24, 2008

Related U.S. Application Data
(63) Continuation-in-part of application No. 11/261,361, filed on Oct. 27, 2005.
Application No. 11/261,361 is a continuation-in-part of application No. 11/083,693, filed on Mar. 17, 2005.
Application No. 11/083,693 is a continuation-in-part of application No. 11/083,708, filed on Mar. 17, 2005.

(51) Int. Cl. H04L 27/28; H04J 11/00

(52) U.S. Cl. 375/260

(57) ABSTRACT

Transmission patterns for pilot symbols transmitted from a mobile station or base station are provided. The pattern allows for improved receipt of the pilot symbols transmitted. In addition, schemes for improving the ability to multiplex pilot symbols without interference and/or biasing from different mobile stations over the same frequencies and in the same time slots.

### I. CROSS REFERENCE TO RELATED APPLICATIONS

This application is a continuation-in-part of application Ser. No. 11/083,693 and application Ser. No. 11/083,708, both filed on Mar. 17, 2005 for a “pilot signal transmission for an orthogonal frequency division wireless communication system” both of which are hereby expressly incorporated by reference.

### II. BACKGROUND OF THE INVENTION

1. Field of the Invention

The present document relates generally to wireless communication and amongst other things pilot information transmission in an orthogonal frequency division wireless communication system.

2. Description of the Related Art

An orthogonal frequency division multiple access (OFDMA) system utilizes orthogonal frequency division multiplexing (OFDM). OFDM is a multi-carrier modulation technique that partitions the overall system bandwidth into multiple (N) orthogonal frequency subcarriers. These subcarriers may also be called tones, bins, and frequency channels. Each subcarrier may be modulated with data. Up to N modulation symbols may be sent on the N total subcarriers in each OFDM symbol period. These modulation symbols are converted to the time-domain with an N-point inverse fast Fourier transform (IFFT) to generate a transformed symbol that contains N time-domain chips or samples.

In a frequency hopping communication system, data is transmitted on different frequency subcarriers in different time intervals, which may be referred to as “hop periods.” These frequency subcarriers may be provided by orthogonal frequency division multiplexing, other multi-carrier modulation techniques, or some other constructs. With frequency hopping, the data transmission hops from subcarrier to subcarrier in a pseudo-random manner. This hopping provides frequency diversity and allows the data transmission to better withstand deleterious path effects such as narrow-band interference, jamming, fading, and so on.

An OFDMA system can support multiple mobile stations simultaneously. For a frequency hopping OFDMA system, a data transmission for a given mobile station may be sent on a “traffic” channel that is associated with a specific frequency hopping (FH) sequence. This FH sequence indicates the specific subcarrier to use for the data transmission in each hop period. Multiple data transmissions for multiple mobile stations may be sent simultaneously on multiple traffic channels that are associated with different FH sequences. These FH sequences may be defined to be orthogonal to one another so that only one traffic channel, and thus only one data transmission, uses each subcarrier in each hop period. By using orthogonal FH sequences, the multiple data transmissions generally do not interfere with one another while enjoying the benefits of frequency diversity.

An accurate estimate of a wireless channel between a transmitter and a receiver is normally needed in order to recover data sent via the wireless channel. Channel estimation is typically performed by sending a pilot from the transmitter and measuring the pilot at the receiver. The pilot signal is made up of pilot symbols that are known a priori by both the transmitter and receiver. The receiver can thus estimate the channel response based on the received symbols and the known symbols.

Part of each transmission from any particular mobile station to the base station, often referred to as a “reverse link” transmission, during a hop period is allocated to transmitting pilot symbols. Generally, the number of pilot symbols determines the quality of channel estimation, and hence the packet error rate performance. However, the use of pilot symbols causes a reduction in the effective transmission data rate that can be achieved. That is, as more bandwidth is assigned to pilot information, less bandwidth becomes available to data transmission.

One type of FH-OFDMA system is a blocked hop system where multiple mobile stations are assigned to a contiguous group of frequencies and symbol periods. In such a system, it is important that pilot information be reliably received from the mobile station, while at the same time reducing the bandwidth that is allocated to pilot information, since the block has a limited amount of symbols and tones available to be used for both pilot and data transmission.

### SUMMARY

In an embodiment, pilot symbol patterns are provided for pilot symbols transmitted from a mobile station or a base station. The pattern allows for improved receipt and demodulation of the pilot symbols transmitted.

In additional embodiments, schemes for improving the ability to multiplex pilot symbols without interference and/or biasing from different mobile stations in a same sector of a base station over the same frequencies and in the same time slots in an OFDM system are provided.

In further embodiments, schemes for reducing the bias or interference for pilot symbols transmitted from different mobile stations in neighboring cells over the same frequencies and in the same time slots in an OFDM system are provided. In other embodiments, methods for altering pilot symbol patterns are provided. Also, in other further embodiments methods for generating pilot symbols are provided.

### BRIEF DESCRIPTION OF THE DRAWINGS

The features, nature, and advantages of the present embodiments may become more apparent from the detailed description set forth below when taken in conjunction with the drawings in which like reference characters identify correspondingly throughout and wherein:

FIG. 1 illustrates a multiple access wireless communication system according to an embodiment;

FIG. 2 illustrates a spectrum allocation scheme for a multiple access wireless communication system according to an embodiment;

FIG. 3A illustrates a block diagrams of a pilot assignment scheme according to an embodiment;

FIG. 3BA illustrates a block diagrams of a pilot assignment scheme according to another embodiment;

FIG. 4A illustrates a pilot symbol scrambling scheme according to an embodiment;

FIG. 4B illustrates a pilot symbol scrambling scheme according to another embodiment;

FIG. 5 illustrates a base station with multiple sectors in a multiple access wireless communication system according to an embodiment;

FIG. 6 illustrates a multiple access wireless communication system according to another embodiment;

FIG. 7 illustrates a block diagram of an embodiment of a transmitter system and a receiver system in a multi-input multi-output multiple access wireless communication system;

FIG. 8 illustrates a flow chart of a method of pilot symbol generation according to an embodiment; and

FIG. 9 illustrates a flow chart of a method of altering pilot symbol patterns according to an embodiment.

### DETAILED DESCRIPTION

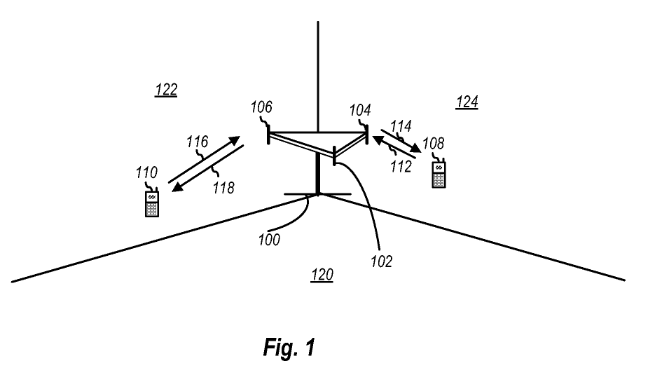

Referring to FIG. 1, a multiple access wireless communication system according to an embodiment is illustrated. A base station 100 includes multiple antenna groups 102, 104, and 106 each including one or more antennas. In FIG. 1, only a single antenna is shown for each antenna group 102, 104, and 106, however, multiple antennas may be utilized for each antenna group that corresponds to a sector of base station 100.

Mobile station 108 is in communication with antenna 104, where antenna 104 transmits information to mobile station 108 over forward link 114 and receives information from mobile station 108 over reverse link 112. Mobile station 110 is in communication with antenna 106, where antenna 106 transmits information to mobile station 110 over forward link 118 and receives information from mobile station 110 over reverse link 116.

Each group of antennas 102, 104, and 106 and/or the area in which they are designed to communicate is often referred to as a sector of the base station. In the embodiment, antenna groups 102, 104, and 106 each are designed to communicate to mobile stations in a sector, sectors 120, 122, and 124, respectively, of the areas covered by base station 100.

A base station may be a fixed station used for communicating with the terminals and may also be referred to as an access point, a Node B, or some other terminology. A mobile station may also be called a mobile station, user equipment (UE), a wireless communication device, a terminal, an access terminal or some other terminology.

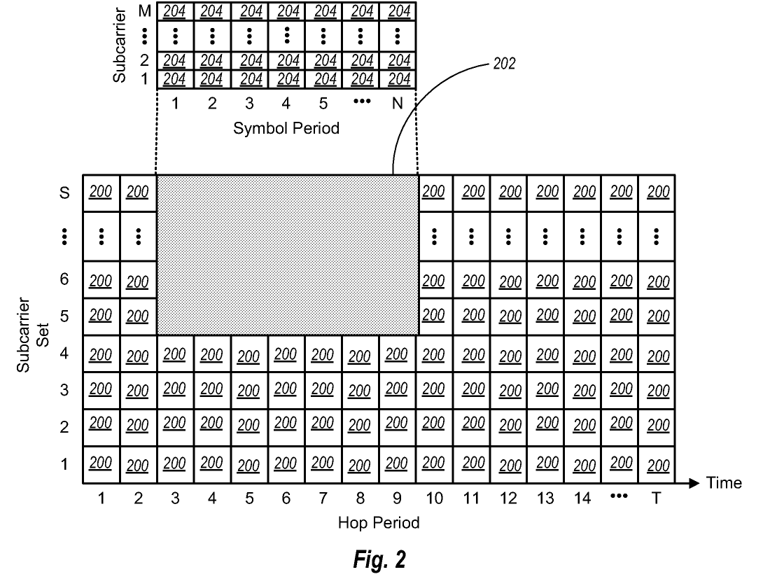

Referring to FIG. 2, a spectrum allocation scheme for a multiple access wireless communication system is illustrated. A plurality of OFDM symbols 200 is allocated over T symbol periods and S frequency subcarriers. Each OFDM symbol 200 comprises one symbol period of the T symbol periods and a tone or frequency subcarrier of the S subcarriers.

In an OFDM frequency hopping system, one or more symbols 200 may be assigned to a given mobile station. In an embodiment of an allocation scheme as shown in FIG. 2, one or more hop regions, e.g. hop region 202, of symbols to a group of mobile stations for communication over a reverse link. Within each hop region, assignment of symbols may be randomized to reduce potential interference and provide frequency diversity against deleterious path effects.

Each hop region 202 includes symbols 204 that are assigned to the one or more mobile stations that are in communication with the sector of the base station and assigned to the hop region. In other embodiments, each hop region is assigned to one or more mobile stations. During each hop period, or frame, the location of hop region 202 within the T symbol periods and S subcarriers varies according to a hopping sequence. In addition, the assignment of symbols 204 for the individual mobile stations within hop region 202 may vary for each hop period.

The hop sequence may pseudo-randomly, randomly, or according to a predetermined sequence, select the location of the hop region 202 for each hop period. The hop sequences for different sectors of the same base station are designed to be orthogonal to one another to avoid “intra-cell” interference among the mobile station communicating with the same base station. Further, hop sequences for each base station may be pseudo-random with respect to the hop sequences for nearby base stations. This may help randomize “inter-cell” interference among the mobile stations in communication with different base stations.

In the case of a reverse link communication, some of the symbols 204 of a hop region 202 are assigned to pilot symbols that are transmitted from the mobile stations to the base station. The assignment of pilot symbols to the symbols 204 should preferably support space division multiple access (SDMA), where signals of different mobile stations overlapping on the same hop region can be separated due to multiple receive antennas at a sector or base station, provided enough difference of spatial signatures corresponding to different mobile stations. To more accurately extract and demodulate signals of different mobile stations, the respective reverse link channels should be accurately estimated. Therefore, it may be desired that pilot symbols on the reverse link enable separating pilot signatures of different mobile stations at each receive antenna within the sector in order to subsequently apply multi-antenna processing to the pilot symbols received from different mobile stations.

Block hopping may be utilized for both the forward link and the reverse link, or just for the reverse link depending on the system. It should be noted that while FIG. 2 depicts hop region 200 having a length of seven symbol periods, the length of hop region 200 can be any desired amount, may vary in size between hop periods, or between different hopping regions in a given hop period.

It should be noted that while the embodiment of FIG. 2 is described with respect to utilizing block hopping, the location of the block need not be altered between consecutive hop periods or at all.

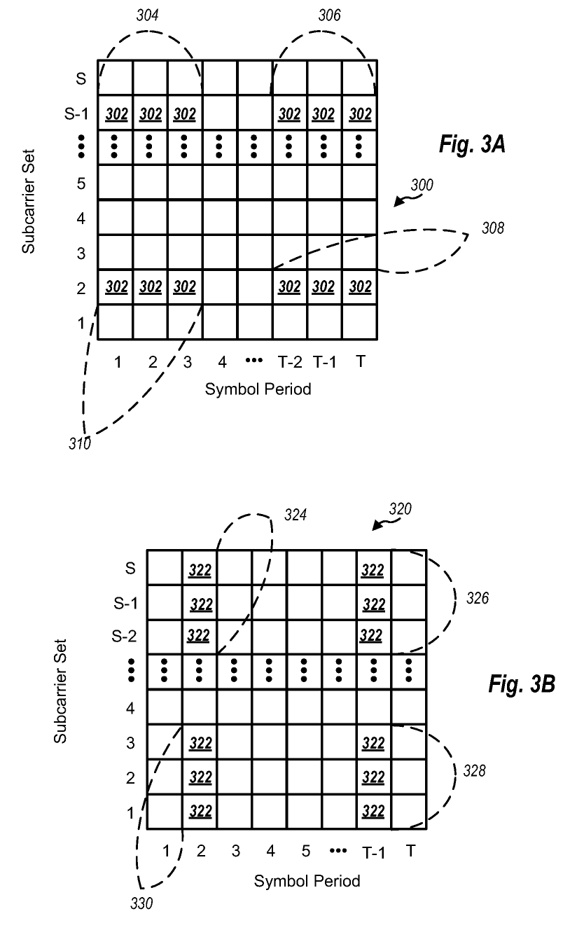

Referring to FIGS. 3A and 3B, block diagrams of pilot assignment schemes according to several embodiments are illustrated. Hop regions 300 and 320 are defined by T symbol periods by S subcarriers or tones. Hop region 300 includes pilot symbols 302 and hop region 320 includes pilot symbols 322, with the remaining symbols periods and tone combinations available for data symbols and other symbols. In an embodiment, pilot symbol locations for each hop regions, i.e. a group of N.sub.S contiguous tones over N.sub.T consecutive OFDM symbols, should have pilot tones located close to the edges of the hop region. This is generally because typical channels in wireless applications are relatively slow functions of time and frequency so that a first order approximation of the channel, e.g. a first order Taylor expansion, across the hop region in time and frequency provides information regarding channel conditions that is sufficient to estimate the channel for a given mobile station. As such, it is preferred to estimate a pair of channel parameters for proper receipt and demodulation of symbols from the mobile stations, namely the constant component of the channel, a zero order term of a Taylor expansion, and the linear component, a first order term Taylor expansion, of the channel across the time and frequency span of the channel. Generally estimation accuracy of the constant component is independent of pilot placement. The estimation accuracy of the linear component is generally preferably achieved with pilot tones located at the edges of the hop region.

Pilot symbols 302 and 322 are arranged in contiguous pilot symbol clusters 304, 306, 308, and 310 (FIG. 3A) and 324, 326, 328, and 330 (FIG. 3B). In an embodiment, each cluster 304, 306, 308, and 310 (FIG. 3A) and 324, 326, 328, and 330 (FIG. 3B) within a hop region, has a fixed number, and often the same number, of pilot symbols within a given hop region. The utilization of clusters 304, 306, 308, and 310 (FIG. 3A) and 324, 326, 328, and 330 (FIG. 3B) of contiguous pilot symbols may, in an embodiment take into account the effect of a multi-user interference caused by inter-carrier interference which results from high Doppler and/or symbol delay spreads. Further, if pilot symbols from mobile stations scheduled on a same hop region are received at substantially different power levels, signals of a stronger mobile station may create a significant amount of interference for a weaker mobile station. The amount of interference is higher at the edges, e.g. subcarrier 1 and subcarrier S, of the hop region and also at the edge OFDM symbols, e.g. symbol periods 1 and T, when the leakage is caused by excess delay spread, i.e. when the portion of channel energy concentrated in the taps that exceed cyclic prefix of the OFDM symbols becomes significant. Therefore, if pilot symbols are located exclusively at the edges of a hop region there may be degradation in channel estimation accuracy and a bias in interference estimation. Hence, as depicted in FIGS. 3A and 3B pilot symbols are placed close to the edges of the hop region, however, avoiding the situation where all the pilot symbols are at the edges of the hop region.

Referring to FIG. 3A, a hop region 300 is comprised of pilot symbols 302. In the case of channels with a pronounced frequency selectivity rather than time selectivity, pilot symbols 302 are located in contiguous pilot symbol clusters 304, 306, 308, and 310 with each pilot symbol cluster 304, 306, 308, and 310 spanning a multiple symbol periods and one frequency tone. The frequency tone is preferably chosen to be close to the edges of the frequency range of the hop region 300, however, not exactly at the edge. In the embodiment of FIG. 3A, none of the pilot symbols 302 in a given cluster are at the edge frequency tones and in each cluster only pilot symbol may be at an edge symbol period.

One rationale behind a “horizontal” shape of the contiguous pilot symbol clusters of pilot symbols 302 is that, for channels with higher frequency selectivity, the first order (linear) component may be stronger in the frequency domain than in the time domain.

It should be noted that one or more pilot symbols in each cluster, in the embodiment of FIG. 3A, may be at a different tone than one or more pilot symbols in a different cluster. For example, cluster 304 may be at tone S and cluster 306 may be at tone S-1.

Referring to FIG. 3B, in the case of channels with a pronounced time selectivity rather than frequency selectivity, pilot symbols 322 are arranged in clusters 324, 326, 328, and 330 of contiguous pilot symbols that each span multiple frequency tones but have a same symbol period of hop region 320. OFDM symbols at the edges of hop region 320, those that have a maximum tone, e.g. tone S, or minimum tone, e.g. tone 1, of the frequency range that defines the S subcarriers, may be included as part of the pilot symbols, since there may be pilot symbols 322 that are at the edges of the hop region 320. However, in the embodiment shown in FIG. 3B, only one pilot symbol in each cluster may be assigned to the maximum or minimum frequency subcarrier.

In the embodiment depicted in FIG. 3B, a channel with higher time selectivity may have a typical pattern that may be obtained by a 90.degree. rotation of the pattern chosen for channels with higher frequency selectivity (FIG. 3A).

It should be noted that one or more pilot symbols in each cluster, in the embodiment of FIG. 3B, may be assigned to a different symbol period than one or more pilot symbols in a different cluster. For example, cluster 324 may be at different symbol period T than cluster 326.

Additionally, as depicted in the embodiments of FIGS. 3A and 3B, pilot patterns are provided so that the clusters, 304, 306, 308, and 310 (FIG. 3A) and 324, 326, 328, and 330 (FIG. 3B), are preferably symmetric with respect to the center of the hop region. The symmetry of the clusters with respect to the center of the hop region may provide improved simultaneous estimation of the channel with respect to time and frequency responses of the channel.

It should be noted that while FIGS. 3A and 3B depict four clusters of pilot symbols per hop region, a fewer or greater amount of clusters may be utilized in each hop region. Further, the number of pilot symbols per pilot symbol cluster may also vary. The total number of pilot symbols and pilot symbol clusters are a function of the number of pilot symbols required by the base station to successfully demodulate data symbols received on the reverse link and to estimate the channel between the base station and the mobile station. Also, each cluster need not have the same number of pilot symbols. The number of mobile stations that can be multiplexed over a single hop region can, in an embodiment, be equal to the number of pilot symbols in a hop region.

In addition, while FIGS. 3A and 3B depict pilot symbol clusters designed either for channels having frequency selectivity or time selectivity the pilot pattern may be such that there are clusters for frequency selective channels as well as clusters for time selective channels in the same pilot pattern, e.g. some clusters arranged in the pattern of clusters 304, 306, 308, or 310 and some clusters arranged in the pattern of clusters 324, 326, 328, or 330.

In some embodiments, the pilot pattern chosen to be utilized may be based upon the conditions for which the channel is being optimized. For example, for channels that may have high-speed movement, e.g. vehicular, of mobile stations a time-selective pilot pattern may be preferred, whereas for slow-speed movement of mobile station, e.g. pedestrians, a frequency selective pilot pattern may be utilized. In other embodiment, the pilot pattern can be chosen based upon channel conditions, a determination made after a pre-determined number of hop periods.

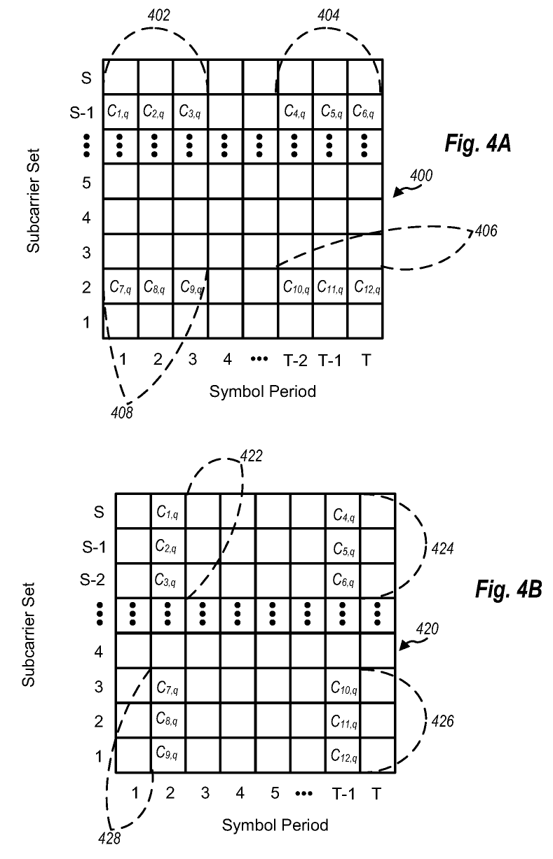

Referring to FIGS. 4A and 4B, pilot allocation schemes according to further embodiments are illustrated. In FIG. 4A, hop regions 400 includes pilot symbols C.sub.1,q, C.sub.2,q, and C.sub.3,q, arranged in cluster 402; C.sub.4,q, C.sub.5,q, and C.sub.6,q, arranged in cluster 404; C.sub.7,q, C.sub.8,q, and C.sub.9,q, arranged in cluster 406; and C.sub.10,q, C.sub.11,q, and C.sub.12,q arranged in cluster 408. In an embodiment, in order to improve spatial diversity in hop regions where multiple mobile stations provide overlapping pilot symbols, the pilot symbols of different mobile stations should be multiplexed in such a way over the same OFDM symbol period and tone so that the pilot symbols are substantially orthogonal when received at the antennas of the cluster of the base station.

In FIG. 4A, each of the pilot symbols C.sub.1,q, C.sub.2,q, C.sub.3,q, C.sub.4,q, C.sub.5,q, C.sub.6,q, C.sub.7,q, C.sub.8,q, C.sub.9,q, C.sub.10,q, C.sub.11,q, and C.sub.12,q are assigned to multiple mobile stations of hop region 400, that is each symbol period includes multiple pilot symbols, from a number of different mobile station stations. Each of the pilot symbols in a pilot symbol cluster, e.g. cluster 402, 404, 406, and 408, are generated and transmitted in such a way that a receiver of the pilots symbols in the cluster, e.g. base station, can receive them so that they are orthogonal with respect to the pilot symbols from each other mobile station in the same cluster. This can be done by applying a predetermined phase shift, e.g. a scalar function to multiply, each of the samples constituting the pilot symbols transmitted by each of the mobile stations. To provide orthogonality, the inner products of vectors representing the sequence of the scalar functions in each cluster for each mobile station may be zero.

Further, in some embodiments, it is preferred that the pilot symbols of each cluster are orthogonal to the pilot symbols of each other cluster of the hop region. This can be provided in the same manner as orthogonality is provided for the pilot symbols within each cluster from a different mobile station, by utilizing a different sequence of scalar functions for the pilot symbols of each mobile station in each cluster of pilot symbols. Mathematical determination of orthogonality can be made by selecting a sequence of scalar multiples for each of the pilot symbols for a particular cluster for the particular mobile station the vector of which is orthogonal, e.g. the inner product is zero, with respect to a vector representing the sequence of scalar multiples used for the pilot symbols of the other mobile stations in all the clusters and the same mobile station in the other clusters.

In an embodiment the number of mobile stations that may be supported, where orthogonality of the pilot symbols across each of the clusters is provided, is equal to the number of pilot symbols that are provided per pilot symbol cluster.

In the embodiments of FIGS. 4A and 4B, the q-th user of Q overlapping users, 1.ltoreq.q.ltoreq.Q, uses the sequence S of size N.sub.P, where N.sub.P is the total number of pilot tones (In FIGS. 4A and 4B, N.sub.P=12):S.sub.q=[S.sub.1,q . . . S.sub.N.sub.P,q].sup.T, 1.ltoreq.q.ltoreq.Q, (1) here (.sup.T) denotes transpose of the matrix containing the sequences. As discussed above, the sequences of scalar functions, in each cluster of pilot symbols, should be different for different mobile stations in order to obtain consistent estimates of the respective channels through the reduction of interference between pilot symbols. Moreover, the sequences should be linearly independent, as such it is preferred that no sequence or vector be a linear combination of the remaining sequences. Mathematically, this may defined in that the N.sub.P.times.Q matrixS=[S.sub.1 . . . S.sub.Q] (2) is of full column rank. It should be noted in the expression (2) above matrix Q.ltoreq.N.sub.P. That is, the number of overlapping mobile stations should not exceed the number of total pilot symbols in the hop region.

Based upon the above, any set of sequences Q with a full-rank S enables consistent channel estimation. However, in other embodiment, the actual estimation accuracy may depend on the correlation properties of S. In an embodiment, as can be determined utilizing equation (1), performance may be improved when any two sequences are mutually (quasi-) orthogonal in the presence of the channel. Mathematically, this condition may be defined by k=1 N P .times. H k .times. S k, p * .times. S k, q .apprxeq. 0.times. .times. for .times. .times. all .times. .times. 1 .ltoreq. p, q .ltoreq. Q, (3) where H.sub.k is a complex channel gain corresponding to the k-th pilot symbol, 1.ltoreq.k.ltoreq.N.sub.p. In a time and frequency invariant channel H.sub.1=H.sub.2= . . . =H.sub.N.sub.P) condition (3) reduces to the requirement of mutually orthogonal sequences: k=1 N P .times. S k, p * .times. S k, q .apprxeq. 0.times. .times. for .times. .times. all .times. .times. 1 .ltoreq. p, q .ltoreq. Q, (4) enforcing this condition for any possible channel realization from a typical set of channels may be impractical. In fact, expression (3) may be satisfied when a channel exhibits limited time and frequency selectivity, which is the case of pedestrian channels with a relatively small delay spread. However, the conditions may be substantially different on vehicular channels and/or channels with a significant delay spread, thereby resulting in performance degradation.

As discussed with respect to FIGS. 3A and 3B, pilot allocation patterns consist of a few clusters of pilot symbols placed close to the edges of the hop region, where each cluster is contiguous in time (FIG. 3A) and/or frequency (FIG. 3B). Since channel variations inside every cluster are generally limited, due to contiguous nature of the pilot symbols in time and frequency and continuity of the channel in time and frequency. Hence making different sequences orthogonal over each cluster allows condition (3) to be met. A potential drawback of this solution is that the number of overlapping mobile stations that can be orthogonal over every cluster is limited to the size of the cluster, denoted here N.sub.c. In the example shown in FIGS. 4A and 4B, N.sub.C=3, and hence up to Q=3 mobile stations can be separated orthogonally in such an embodiment. In fact, a fairly small number of Q is sufficient in many practical scenario. When Q>N.sub.C, it may be difficult to keep all mobile stations orthogonal over every cluster, since there may be some inter-symbol interference. Hence, approximate orthogonality may be sufficient, with some performance loss of time and/or frequency varying channels if Q>N.sub.C.

In an embodiment, a set of design parameters for the sequences of scalar functions S=[S.sub.1 . . . S.sub.Q] may be defined by: [0056] Any two sequences are orthogonal over the entire set of pilot symbols, thereby satisfying k=1 N P .times. S k, p * .times. S k, q=0.times. .times. for .times. .times. all .times. .times.1 .ltoreq. p, q .ltoreq. Q, (5) [0057] Subsequent groups of N.sub.C sequences are such that any two sequences within a group are mutually orthogonal over any cluster of pilots: k=1 N C .times. S k+IN C, p * .times. S k+IN C, q=0, nN C+1.ltoreq. p, q .ltoreq. min .times. {(n+1) times. N C, Q}, 0.ltoreq. n<Q N C, 0.ltoreq. l<M C. (6) [0058] All the elements S.sub.k,q of all the sequences have substantially equal absolute values, e.g. approximately the same power. where M.sub.C denotes the total number of clusters of size N.sub.C, so that the number of pilots N.sub.P=M.sub.CN.sub.C.

In an embodiment, the sequences S=[S.sub.1 . . . S.sub.Q] are created using exponential functions so that so that the same energy per symbol provided by each sequence. Further, in this embodiment, the groups of N.sub.C sequences may be made mutually orthogonal within each cluster, regardless of cluster size since exponents are not limited to particular multiples, and with the sequences used in every other cluster across all of the pilot symbols, by (i) defining exponential sequences within each cluster; and (ii) populating the intra-cluster portions across clusters. This can be seen equation (7) where a N.times.N Discrete Fourier Transform (DFT) basis is defined. F .function. (N)=[F 1, 1 .function. (N) F 1, 2 .function. (N) F 1, N .function. (N) F 2, 1 .function. (N) F 2, 1 .function. (N) F 2, N .function. (N) F N, 1 .function. (N) F N, 2 .function. (N) F N, N .function. (N)]=[1 1 1 e I2.pi. .times. 1 N e I2.pi. .times. 2 N e I2.pi. .times. (N−1).times. 2 N e I2.pi. times. N−1 N e I2.pi. .times. 2 .times. (N−1) N e I2.pi. .times. (N−1) times. (N−1) N] (7)

The above expression (7) may be written in a compact block form as follows: S=[S.sub.1, . . . , S.sub.Q]=F(M.sub.C).sym.F(N.sub.C).sub.:. 1:Q (8) where .sub.:,1:Q denotes matrix block spanned by columns 1 through Q of the original matrix. A more general form of S may be given by S=[S.sub.1, . . . , S.sub.Q]=V.sym.U.sub.:,1:q (9) where U is an arbitrary N.sub.C.times.N.sub.C unitary matrix (U*U=I.sub.N.sub.P) and Vis an arbitrary M.sub.C.times.M.sub.C unitary matrix (U*U=I.sub.M.sub.C).

In an embodiment the number of mobile stations that may be supported, where orthogonality of the pilot symbols across each of the clusters is provided, is equal to the number of pilot symbols that are provided per pilot symbol cluster.

In an embodiment, the exponential functions utilized to multiply the samples of the pilot symbols are generated utilizing a discrete Fourier transform function, which is well known. In embodiments where the discrete Fourier transform function is used to generate the symbols for transmission, an extra phase shift is applied during formation of the symbols using the discrete Fourier transform function in generating the symbols for transmission.

In the embodiments of FIGS. 4A and 4B, the inner products of vectors representing the sequence of the scalar functions in each cluster for each mobile station may be zero. However, in other embodiments this is not the case. It may be arranged so that only quasi-orthogonality between the sequences of the scalar functions in each cluster for each mobile station is provided.

Further in those situations, where the number of mobile stations assigned to the hop region is less than the number of pilot symbols assigned to the hop region, the scalar shifts may still be decoded at the base station in order to be utilized to perform interference estimation. Therefore, these pilot symbols may be utilized for interference estimation since they are orthogonal or quasi-orthogonal with respect to pilot symbols by the other mobile stations assigned to the hop region.

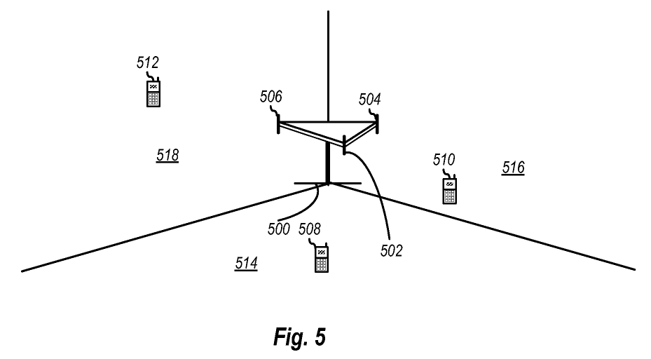

Referring to FIG. 5, a base station with multiple sectors in a multiple access wireless communication system according to an embodiment is illustrated. A base station 500 includes multiple antenna groups of antennas 502, 504, and 506. In FIG. 5, only one antenna is shown for each antenna group 502, 504, and 506, however, multiple antennas may be utilized. The multiple antennas of each antenna group 502, 504, and 506 may be utilized to provide spatial diversity at the base station to signals transmitted from mobile stations in a corresponding sector, in addition to the spatial diversity provided to the different physical locations of the different mobile stations.

Each antenna group 502, 504, and 506 of base station 500 is configured to communicate with mobile stations in a sector to be covered by base station 500. In the embodiment of FIG. 5, antenna group 502 covers sector 514, antenna group 504 covers sector 516, and antenna group 506 covers sector 518. Within each sector, as described with respect to FIG. 4, the pilot symbols transmitted from the mobile stations may be accurately demodulated and used for channel estimation, and other functionally, at the base station due the orthogonality or the approximately orthogonality between all of the inter-sector pilot symbol clusters.

However, intra-sector interference may exist for mobile stations near the boundary of a sector, e.g. mobile station 510 which is near a boundary of sectors 514 and 516. In such a case, pilot symbols from mobile station 510 may be at lower powers than pilot symbols from other mobile stations in both sectors 514 and 516. In such a situation, mobile station 510 could eventually benefit from reception at both sectors antennas, especially when its channel to the serving sector, i.e. sector 516 signals may fade if power is increased from antenna 504. In order to fully benefit from the reception from antenna 502 of sector 514, accurate estimate of the channel of mobile station 510 between antenna 502 of sector 514 should be provided. However, if the same or substantially the same sequences are used for the scalar multiples of the pilot symbols in different sectors with the present pilot design, pilot symbols transmitted by mobile station 510 may collide with pilot symbols transmitted by mobile station 508 which is scheduled in sector 514 on the same hop region as mobile station 510 is scheduled in sector 516. Further, in some cases depending on the power control strategy utilized by the base station to control the mobile stations, the power level of symbols from mobile station 508 may substantially exceed the signal level of mobile station 510 at antenna group 502 of the sector 514, especially when mobile station 508 is close to the base station 500.

In order to combat the intra-sector interference that may arise, scrambling codes may be used for the mobile stations. The scrambling code may unique to individual mobile stations or may be the same for each of the mobile stations communicating with an individual sector. In an embodiment, these specific scrambling codes allow antenna group 502 to see a composite channel of mobile stations 508 and 510.

In the case where a single mobile station is assigned to an entire hop region, user specific scrambling sequences may be provided so that every mobile station in a given sector makes use of the same pilot sequence; the construction of these sequences is described with respect to FIGS. 4A and 4B. In the example of FIG. 5, mobile stations 508, 510, and 512 may have different user specific scrambling sequences and therefore sufficient channel estimation may be achieved.

Where multiple mobile stations are, or may be, assigned to a same hop region, two approaches may be utilized to reduce intra-cluster interference. Firstly, user specific scrambling sequences may be utilized if the cluster size N.sub.C is greater or equal than the number of overlapping mobile stations in each sector Q times the number of sectors in the cell. If this is the case, distinct sets of Q different user-specific scrambling codes may be assigned to different sectors.

However, if the cluster size N.sub.C is less than the number of overlapping mobile stations in each sector Q times the number of sectors in the cell, this may be important if a goal of system design is to keep N.sub.C to maintain a limited pilot overhead, user specific scrambling codes may not be effective to reduce inter-cell interference. In such cases, a sector specific scrambling sequence may be utilized along with the user specific scrambling sequence.

A sector specific scrambling sequence is a sequence X.sub.s=[X.sub.1,s, . . . , X.sub.N.sub.p.sub.,s].sup.T of N.sub.P complex functions that multiply the respective elements of the sequences S=[S.sub.1 . . . S.sub.Q], for all mobile stations in a same sector. In a cell consisting of S sectors, a set of S sector specific scrambling sequences X.sub.1, . . . , X.sub.X may be utilized to multiply the sequences S=[S.sub.1. S.sub.Q] of the mobile stations. In such a case, mobile stations within different sectors, for example sector 514 and 516 that may have mobile stations that utilize the same user specific scrambling sequences S=[S.sub.1 . . . S.sub.Q] may differ due to different sector specific scrambling sequences X.sub.s.sub.1 and X.sub.S.sub.2 utilized to multiply the user specific scrambling sequence.

Similarly to user-specific scrambling, it is preferred that all of the entries of X.sub.1, . . . , X.sub.S have approximately equal absolute values to maintain approximately equal power between the pilot symbols. In other embodiments, it is preferred that entries of X.sub.1, . . . , X.sub.S be such that any pair of pilot symbols in a pilot symbol cluster, corresponding to any two combinations of user specific and sector specific scrambling sequences satisfies, should satisfy condition (3). One way to approach to the choice of contents of each sector specific sequence X.sub.1, . . . , X.sub.S consists of an exhaustive search of sequences such as the elements of every sequence are taken from some constant modulus (PSK) constellation such as QPSK, 8-PSK. The selection criterion may be based upon the “worst case” channel estimation error variance corresponding to the “worst” combination of mobile stations from different sectors and different user specific scrambling that are based upon the potential channel environment. Channel estimation error may be computed analytically based on statistical properties of the channel. Specifically, a trace of the covariance matrix of a channel estimate that assume channel correlation structure based on an anticipated fading model and parameters such as mobile station velocity, which defines time selectivity, and propagation delay spread which defines frequency selectivity. The analytical expressions for the minimum achievable channel estimation error subject to a given correlation structure of the true channel are known in the art. Other similar criteria may be used to optimize the choice of X.sub.x, . . . , X.sub.s as well.

In an embodiment where Quadrature Amplitude Modulation is utilized as the modulation scheme, a set of sector specific scrambling sequences X.sub.1, . . . , X.sub.x that may be utilized is shown in Table 1 below. Each entry of the table specifies I and Q components of every X.sub.k,s, 1.ltoreq.s.ltoreq.S and 1.ltoreq.k.ltoreq.N.sub.P with S=3 and N.sub.P=12. TABLE-US-00001 TABLE 1 k 1 2 3 4 5 6 7 8 9 10 11 12 s=1 {+1, +0} {+1, +0} {+1, +0} {+1, +0} {+1, +0} {+1, +0} {+1, +0} {+1, +0} {+1, +0} {+1, +0} {+1, +0} {+1, +0} s=2 {+1, +0} {+1, +0} {−1, +0} {+1, +0} {+0, −1} {+1, +0} {+1, +0} {+0, −1} {+0, +1} {+0, +1} {+0, +1} {+0, +1} s=3 {+0, +1} {−1, +0} {+1, +0} {+1, +0} {+0, +1} {+0, −1} {+0, −1} {+0, +1} {+1, +0} {+0, −1} {+1, +0} {−1, +0}

In an embodiment where Quadrature Amplitude Modulation is utilized as the modulation scheme, a set of sector specific scrambling sequences X.sub.1, . . . , X.sub.S that may be utilized is shown in Table 1 below. Each entry of the table specifies I and Q components of every X.sub.k,s, 1.ltoreq.s.ltoreq.S and 1.ltoreq.k.ltoreq.N.sub.P with S=3 and N.sub.P=12.

In some embodiments, each cell in a communication network may utilize the same sequences for sector specific scrambling sequences.

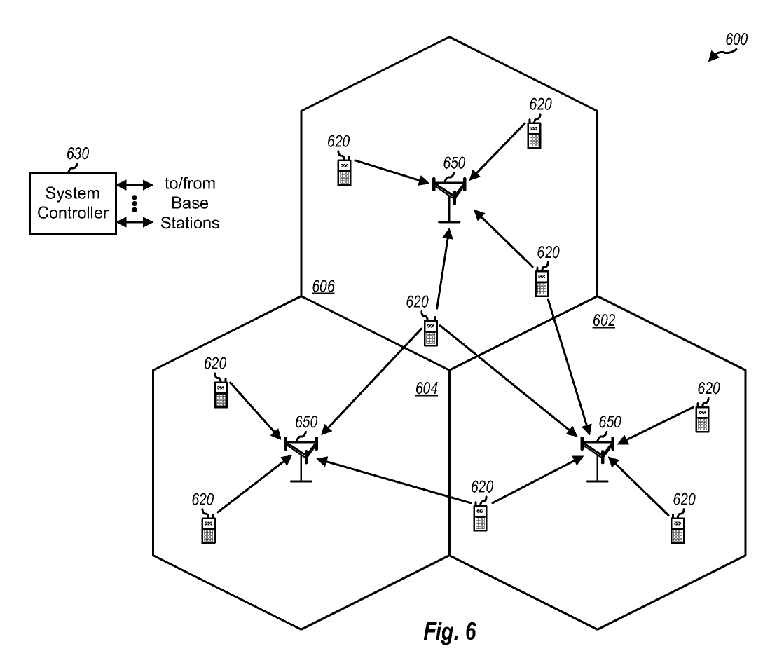

Referring to FIG. 6, a multiple access wireless communication system 600 according to another embodiment is illustrated. In the event when the same sets of user specific and sector specific scrambling sequences are utilized in multiple cells, e.g. cells 602, 604, and 606, interference coming from the adjacent cells may lead to channel estimation accuracy degradation due to pilot symbol collision. For example, a channel estimate within the sector of interest may be biased by the channel of a mobile station from the adjacent cell which mobile station has the same user specific and sector specific scrambling. To avoid such a bias, a cell specific scrambling may be utilized, in addition to the user specific scrambling and sector specific scrambling. A cell specific scrambling schema may be defined by Y.sub.c=[Y.sub.1,c, . . . Y.sub.N.sub.P.sub.,s].sup.T which is a vector of scalar functions that multiply the respective sequence of pilot symbols for every mobile station in the cell. The overall sequences of pilot symbols Z.sub.(q,s,c)=[Z.sub. 1,(q,s,c), . . . , Z.sub.N.sub.P.sub.,(q,s,c)].sup.T which corresponds to a mobile station with q-th user specific scrambling in the s-th sector of the c-th cell may defined as follows. If sector specific scrambling is utilized:Z.sub.k,(q,s,c)=S.sub.k,qX.sub.k,sY.sub.k,c, 1.ltoreq.k.ltoreq.N.sub.P, 1.ltoreq.s.ltoreq.S, c=1, 2, . . . (10) If sector specific scrambling is not utilized:Z.sub.k,(q,s,c)=S.sub.k,qY.sub.k,c, 1.ltoreq.k.ltoreq.N.sub.P, .ltoreq.s.ltoreq.S, c=1, 2, . . . . (11)

As already mentioned, the use of sector specific scrambling is recommended when Q>1 and is not recommended when Q=1.

Unlike user specific and sector specific scrambling, no particular optimization of cell specific scrambling sequences need be utilized. The two design parameters that may be utilized are that: [0080] All the elements of cell specific scrambling sequences have equal modulus. [0081] Cell specific scrambling sequences differ substantially for different cells.

In the absence of pre-determined assignment of cell specific scrambling sequences over a network of base stations, a (pseudo)-random cell specific scrambling sequences from some constant modulus (PSK) constellation such as QPSK, 8-PSK may be utilized in forming the Y cell specific sequences. To further enhance randomization of cell specific scrambling and avoid bad steady combinations of scrambling sequences, cell specific scrambling may be changed periodically in a (pseudo-)random fashion. In some embodiments, the periodic change may be every frame, superframe, or multiple frames or superframes.

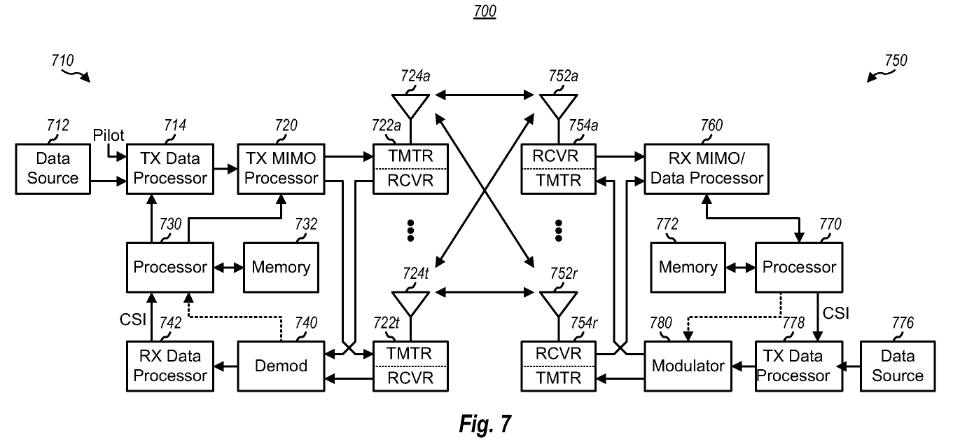

FIG. 7 is a block diagram of an embodiment of a transmitter system 710 and a receiver system 750 in a MIMO system 700. At transmitter system 710, traffic data for a number of data streams is provided from a data source 712 to a transmit (TX) data processor 714. In an embodiment, each data stream is transmitted over a respective transmit antenna. TX data processor 714 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed on provided by controller 130.

The modulation symbols for all data streams are then provided to a TX processor 720, which may further process the modulation symbols (e.g., for OFDM). TX processor 720 then provides N.sub.T modulation symbol streams to N.sub.T transmitters (TMTR) 722a through 722t. Each transmitter 722 receives and processes a respective symbol stream to provide one or more analog signals, and further conditions (e.g., amplifies, filters, and upconverts) the analog signals to provide a modulated signal suitable for transmission over the MIMO channel. N.sub.T modulated signals from transmitters 722a through 722t are then transmitted from N.sub.T antennas 124a through 124t, respectively.

At receiver system 750, the transmitted modulated signals are received by N.sub.R antennas 752a through 752r and the received signal from each antenna 752 is provided to a respective receiver (RCVR) 754. Each receiver 754 conditions (e.g., filters, amplifies, and downconverts) a respective received signal, digitizes the conditioned signal to provide samples, and further processes the samples to provide a corresponding “received” symbol stream.

An RX data processor 760 then receives and processes the N.sub.R received symbol streams from N.sub.R receivers 754 based on a particular receiver processing technique to provide N.sub.T “detected” symbol streams. The processing by RX data processor 760 is described in further detail below. Each detected symbol stream includes symbols that are estimates of the modulation symbols transmitted for the corresponding data stream. RX data processor 760 then demodulates, deinterleaves, and decodes each detected symbol stream to recover the traffic data for the data stream. The processing by RX data processor 760 is complementary to that performed by TX processor 720 and TX data processor 714 at transmitter system 710.

RX processor 760 may derive an estimate of the channel response between the N.sub.T transmit and N.sub.R receive antennas, e.g., based on the pilot information multiplexed with the traffic data. RX processor 760 may identify the pilot symbols according to pilot patterns stored in memory, e.g. memory 772 that identify the frequency subcarrier and symbol period assigned to each pilot symbol. In addition, the user specific, sector specific, and cell specific scrambling sequences may be stored in memory so that they may be utilized by RX processor 760 to multiple the received symbols so that the proper decoding can occur.

The channel response estimate generated by RX processor 760 may be used to perform space, space/time processing at the receiver, adjust power levels, change modulation rates or schemes, or other actions. RX processor 760 may further estimate the signal-to-noise-and-interference ratios (SNRs) of the detected symbol streams, and possibly other channel characteristics, and provides these quantities to a controller 770. RX data processor 760 or controller 770 may further derive an estimate of the “operating” SNR for the system. Controller 770 then provides channel state information (CSI), which may comprise various types of information regarding the communication link and/or the received data stream. For example, the CSI may comprise only the operating SNR. The CSI is then processed by a TX data processor 778, which also receives traffic data for a number of data streams from a data source 776, modulated by a modulator 780, conditioned by transmitters 754a through 754r, and transmitted back to transmitter system 710.

At transmitter system 710, the modulated signals from receiver system 750 are received by antennas 724, conditioned by receivers 722, demodulated by a demodulator 740, and processed by a RX data processor 742 to recover the CSI reported by the receiver system. The reported CSI is then provided to controller 730 and used to (1) determine the data rates and coding and modulation schemes to be used for the data streams and (2) generate various controls for TX data processor 714 and TX processor 720.

Controllers 730 and 770 direct the operation at the transmitter and receiver systems, respectively. Memories 732 and 772 provide storage for program codes and data used by controllers 730 and 770, respectively. The memories 732 and 772 store the pilot patterns in terms of cluster locations, user specific scrambling sequences, sector specific scrambling sequences, if utilized, and cell specific scrambling sequences, if utilized. In some embodiments, multiple pilot patterns are stored in each memory so that the transmitter may transmit and the receiver may receive both frequency selective pilot patterns and time selective pilot patterns. Also, combination pilot patterns having clusters geared for time selective channels and frequency selective channels may be utilized. This allows a transmitter to transmit a specific pattern based upon a parameter, such a random sequence, or in response to an instruction from the base station.

Processors 730 and 770 then can select which of the pilot patterns, user specific scrambling sequences, sector specific scrambling sequences, and cell specific scrambling sequences are to be utilized in transmission of the pilot symbols.

At the receiver, various processing techniques may be used to process the N.sub.R received signals to detect the N.sub.T transmitted symbol streams. These receiver processing techniques may be grouped into two primary categories (i) spatial and space-time receiver processing techniques (which are also referred to as equalization techniques); and (ii) “successive nulling/equalization and interference cancellation” receiver processing technique (which is also referred to as “successive interference cancellation” or “successive cancellation” receiver processing technique).

While FIG. 7 illustrates a MIMO system, the same system may be applied to a multi-input single-output system where multiple transmit antennas, e.g. those on a base station, transmit one or more symbol streams to a single antenna device, e.g. a mobile station. Also, a single output to single input antenna system may be utilized in the same manner as described with respect to FIG. 7.

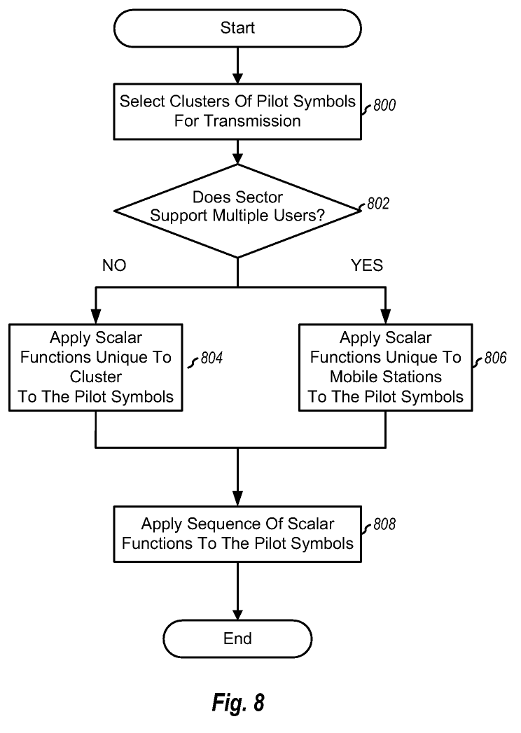

Referring to FIG. 8, a flow chart of a method of pilot symbol generation according to an embodiment is illustrated. A plurality of pilot symbol clusters is selected to be transmitted during a hop region from a particular mobile station, block 800. These pilot symbol clusters may be all aligned for transmission in a frequency selective (FIG. 3A), a time selective channel (FIG. 3B), or a combination of clusters some of which are aligned for transmission in a frequency selective and a time selective channel.

Once the pilot symbol clusters are selected, a determination is made as to whether the cluster of the base station in which the mobile station is communicating supports, or is in communication with, multiple mobile stations, block 802. This determination may be based upon predetermined knowledge of the network in which the mobile station. Alternatively, this information may be transmitted from the sector for the base station as part of its pilot information or broadcast messages.

If the cluster does not support communication, or is not currently in communication with multiple mobile stations, then scalar functions are applied to the pilot symbols that are unique to the cluster with which the mobile station is communicating, block 804. In an embodiment, the scalar functions for each sector may be stored in the mobile station and utilized depending on a sector identification signal that is part of its part of its pilot information or broadcast messages.

If the cluster does support communication with multiple mobile stations, then scalar functions are applied to the pilot symbols that are unique to the mobile station, block 806. In some embodiments, the scalar functions for each mobile station may be based upon its unique identifier used for registration or provided to the device at the time of manufacture.

After scalar functions, that are unique either to the sector with which the mobile station is communicating or the mobile station itself, are applied to the pilot symbols, another sequence of scalar functions is applied to the pilot symbols, block 808. The sequence of scalar functions relates to the cell in which the mobile station is communicating. This scalar function may vary over time, if each cell is not specifically assigned scalar functions that are known by or provided to the mobile stations. After this operation, the pilot symbols may be transmitted from the mobile station to base station.

The scalar functions discussed with respect to FIG. 8, may in an embodiment involve a phase shift of each of the samples that constitute the pilot symbols. As discussed with respect to FIGS. 4A, 4B, 5, and 6 the scalar functions are selected so that each cluster of pilot symbols is orthogonal to each other set of pilot symbols from the same mobile station in other pilot symbol clusters and in the same and other pilot symbol clusters for other mobile stations the same sector of the base station.

In addition, the blocks described with respect to FIG. 8 may each be implemented as one or more instructions on a computer readable media, such as a memory, which are implemented by a processor, controller, or other electronic circuitry.

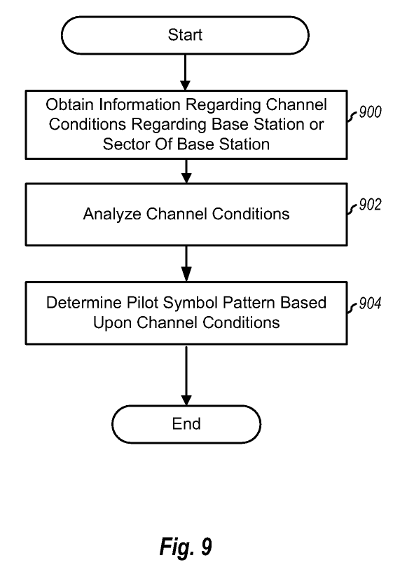

Referring to FIG. 9, a flow chart of a method of altering pilot symbol patterns according to an embodiment is illustrated. Information regarding channel conditions is obtained, block 900. The information may comprise SNR ratios at one or more sectors of the base stations, a selectivity of the channel at the base station, the desired traffic type, pedestrian or vehicular to which the base station is to be optimized, delay spreads, or other characteristics of the channel. Further, the information may relate to periods of time, may be part of a regular maintenance operation on the base station or network of base stations, may be based on increased loading of the base station or network of base stations, or other times.

The information is analyzed to determine the channel conditions of the sector or base station, block 902. The analysis may be a determination whether the channel is frequency selective, time selective, or a combination of both. The analysis is then utilized to determine a pilot symbol pattern that is to be transmitted from mobile stations that may communicate with the sector or base station, block 904. These pilot symbol clusters may be all aligned for transmission in a frequency selective (FIG. 3A), a time selective channel (FIG. 3B), or a combination of clusters some of which are aligned for transmission in a frequency selective and a time selective channel. The specific pilot pattern selected may then be used by all of the mobile stations that communicate with the base station or sector until such time as the diagnostic is performed again for the base station or sector.

To implement a specific pilot pattern at mobile stations communicating at a base station or base station sector, an instruction may be sent from the base station or sector to the mobile stations as part of the initialization or set-up procedure. In some embodiments, information as which pilot pattern, user specific scrambling sequence, sector specific scrambling sequence, and/or cell specific scrambling sequence is to be utilized may transmitted in a preamble of one or more data packets that are transmitted from a base station to a mobile station at regular intervals or during initialization or set-up.

Those skilled in the art will recognize that the embodiments described above embrace a variety of different designs. For example, in one exemplary design each user's data symbols may be transmitted in a group of time frequency resources (i.e. a tile or resource block) where each group is a substantially contiguous set of frequencies and data symbols. (Some puncturing may be allowed.) The set of tiles or may not span the entire bandwidth. The base station transmits the pilot symbols within each tile. If N tiles span the entire system bandwidth, the base station may transmit pilot symbols in M tiles where M<=N. The terminal does channel estimation based on the pilots present in the tiles occupied by its data symbols. For each tile, the terminal may do channel estimation based only on the pilots present in that particular tile.

It should be noted that the analysis may also be utilized to determine the number of pilot symbols to be transmitted in each cluster of pilot symbols and the groupings of pilot symbols. Also, the blocks described with respect to FIG. 9 may each be implemented as one or more instructions on a computer readable media, such as a memory or removable media, which are implemented by a processor, controller, or other electronic circuitry.

The techniques described herein may be implemented by various means. For example, these techniques may be implemented in hardware, software, or a combination thereof. For a hardware implementation, the processing units within a base station or a mobile station may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

The previous description of the disclosed embodiments is provided to enable any person skilled in the art to make or use the present invention. Various modifications to these embodiments may be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for estimating a channel, the method comprising:
receiving a plurality of tiles, each of the plurality of tiles having a plurality of data symbols and a plurality of pilot symbols; and
estimating the channel based on the plurality of pilot signals in the plurality of tiles.

2. A method of wireless communication, comprising:
transmitting a first group of data symbols; and
transmitting a first group of pilot symbols,
wherein said first group of data symbols and said first group of pilot symbols are located in a first hop region.

3. The method of claim 1, wherein said first group of data symbols is for a specific terminal.

4. The method of claim 1, wherein said first group of data symbols is for a plurality of terminals.

5. The method of claim 1, further comprising:
providing N hop regions, said N hop regions including said first hop region, N being a positive integer; and
transmitting a second group of data symbols and a second group of pilot symbols, said second group of data symbols and said second group of pilot symbols being located in one of said N hop regions.

6. The method of claim 4, wherein said N hop regions does not span an entire system bandwidth.

7. The method of claim 4, wherein said N hop regions span an entire system bandwidth.

8. The method of claim 6, further comprising transmitting pilot symbols in M hop regions, M being a positive integer not greater than said N.

9. An apparatus for wireless communication, comprising a transmitter operable to transmit a first group of data symbols and a first group of pilot symbols, wherein said first group of data symbols and said first group of pilot symbols are located in a first hop region.

10. The apparatus of claim 9 wherein said transmitter is operable to hop over N hop regions including said first hop region, N being a positive integer; and transmit a second group of data symbols and a second group of pilot symbols, said second group of data symbols and said second group of pilot symbols being located in one of said N hop regions.

11. A method of wireless communication, comprising:
receiving a first group of data symbols and a first group of pilot symbols, said first group of data symbols and said first group of pilot symbols being located in a first hop region; and
performing channel estimation based on said first group of pilot symbols.

12. The method of claim 11, wherein at least part of said first group of data symbols is for a terminal, and said channel estimation is performed for said terminal.

13. The method of claim 11, further comprising:
receiving a second group of data symbols and a second group of pilot symbols, said second group of data symbols and said second group of pilot symbols being located in a second hop region; and
performing channel estimation based on said first group of pilot symbols and said second group of pilot symbols.

14. The method of claim 13, wherein at least part of said first group of data symbols is for a terminal, at least part of said second group of data symbols is for said terminal, and said channel estimation is performed for said terminal.

15. An apparatus for wireless communication, comprising:
means for transmitting a first group of data symbols; and
means for transmitting a first group of pilot symbols,
wherein said first group of data symbols and said first group of pilot symbols are located in a first hop region.

16. The apparatus of claim 15, further comprising:
means for providing N hop regions, said N hop regions including said first hop region, N being a positive integer; and
means for transmitting a second group of data symbols and a second group of pilot symbols, said second group of data symbols and said second group of pilot symbols being located in one of said N hop regions.

17. A computer-readable medium comprising:
code for generating a first group of data symbols; and
code for transmitting a first group of pilot symbols,
wherein said first group of data symbols and said first group of pilot symbols are located in a first hop region.

18. The computer-readable medium of claim 17, further comprising:
code for hopping over N hop regions, said N hop regions including said first hop region, N being a positive integer; and
code for transmitting a second group of data symbols and a second group of pilot symbols, said second group of data symbols and said second group of pilot symbols being located in one of said N hop regions.
